(19) United States
(12) Patent Application Publication
(10) Pub. No.: US 2003/0104921 A1
(43) Pub. Date: Jun. 5, 2003

(54) Silicon nitride ceramic with a high mechanical strength at room temperature and at elevated temperature

(75) Inventors: Guenter Riedel, Kelkheim (DE); Hartmut Xruener, Eppstein (DE); Hartmut Kruener, Eppstein (DE); Matthias Steiner, Roethenbach (DE); Peter Stingl, Lauf (DE)

Correspondence Address: FOLEY AND LARDNER, SUITE 500, 3000 K STREET NW, WASHINGTON, DC, 20007, US

(73) Assignee: CERAMTEC AG INNOVATIVE CERAMIC ENGINEERING

(21) Appl. No.: 10/147,919

(22) Filed: May 20, 2002

Related U.S. Application Data
(63) Continuation of application No. 09/509,838, filed on Dec. 6, 2000, now abandoned.

(51) Int. Cl. C04B 35/599

(52) U.S. Cl. 501/98.1; 501/98.2

(57) ABSTRACT

The invention relates to cast parts which contain at least 87 wt. % silicon nitride and up to 13 wt. % of an additive combination comprised of Al₂O₃ and Y₂O₃. The initial composition of the mass formulation starts with Y₂O₃/Al₂O₃ ratios of less than 1.1, preferably with Y₂O₃ Al₂O₃ ratios of 0.2 to 1.09. 1% to 20% of the Y₂O₃ portion can thus be substituted by an additional element of the group IVb of the periodic table or by the oxide thereof. The cast parts can comprise up to 1.0 wt. % HfO₂ and/or ZrO₂. Said cast parts preferably have a thickness >98% of the theoretic thickness. At room temperature, the bending strength of the inventive cast parts amounts to ≧1100 MPa and amounts to ≧850 MPa at 1000° C. The inventive cast parts correspond to the formula Si_{6-z}Al_{z}O_{z}N_{8-z}. The degree of substitution z thus amounts to 0.20 to 0.60, preferably from 0.22 to 0.54, especially from 0.3 to 0.35.

The present invention relates to ceramic materials of silicon nitride with sintering additives in the form of yttrium oxide and aluminium oxide, which materials have high mechanical strengths at room temperature and at elevated temperatures.

It is known that silicon nitride ceramics with finely crystalline, acicular β-Si₃N₄ crystallites can have high strengths at room temperature as a result of minimising of strength-limiting structural defects. According to EP-A-O610 848 A2, this is achieved by optimising the production process, in particular the sintering process. Yoshimura (Journ. Ceram. Soc. Japan; 103 (1995) 1872-1876) describes a Si₃N₄ material with sintering additives in the form of Y₂O₃ and Al₂O₃ that has a particularly finely crystalline structure consisting of prismatic and rounded crystallites with a mean grain width of 0.1 μm and a mean grain length of 0.5 μm. The material contains 85 vol. % of β-Si₃N₄ crystallites and 15 vol. % of α-Si₃N₄. These materials comprise β′-α′-sialon composites that have a relatively poor sintering activity Hoffman, M. J., MRS Bulletin February 1995, 28-32). They are sintered below the temperature that leads to a complete α-β transition. The disadvantage is that either long sintering times are necessary, or high levels of sintering additives and/or fluxes are required in order to achieve a complete compaction. In the latter case the relatively high proportion of vitreous phase then has to be reduced by crystallisation by means of subsequent prolonged tempering processes, in order to achieve high strengths at elevated temperatures.

The Strengths disclosed by Yoshimura are 2000 MPa, at room temperature, 1900 MPa at 800° C. and 1000 MPa at 1200° C. (measurement method: 3-point bending test, this method yields higher strength test results than the 4-point bending test generally employed in the investigations described in the European literature). The fracture toughness K_{1c} is found to be 5.8 MPa·m^{½}. This means that the material withstands very high mechanical short-term stresses. On account of the relatively low resistance to crack propagation (low K_{1c} value) the long-term stress behaviour may be regarded as unsatisfactory.

EP-A-O520 211 describes the addition of molybdenum silicide to silicon nitride ceramics in order to improve the strength at elevated temperatures as well as the oxidation stability. The strength level at room temperature, is relatively low, with a maximum value of 763 MPa; cutting tools are described as one application.

A blank of Si₃N₄ with sintering additives in the form of yttrium oxide and aluminium oxide is known from EP-A-O 603 787, in which the weight ratio Y₂O₃/Al₂O₃ should be in tie range from 1.1 to 3.4. The mechanical strengths of the ceramics are greater than 850 MPa at room temperature and are greater than 800 MPa at a temperature of 800° C.

The-object of the present invention in to produce a material that has improved mechanical strengths compared to the prior art at room temperature as well as in the temperature range up to 1000° C.

This object is achieved by the features of the main claim. Preferred embodiments of the solution according to the invention are characterised in the subclaims.

The solution according to the invention provides for shaped bodies that contain at least 87 wt. % of silicon nitride and up to 13 wt. % of an additive combination of Al₂O₃ and Y₂O₃, wherein Y₂O₃/Al₂O₃ weight ratios of less than 1.1 and preferably Y₂O₃/Al₂O₃ weight ratios of 0.2 to 1.09 are adopted in the initial composition of the formulation. 1% to 20% of the Y₂O₃ fraction may in this connection be replaced by another element of Group IVb of the periodic system or by an oxide thereof. The blanks may contain up to 1.0 wt. % of HfO₂ and/or ZrO₃, and preferably have a density of >98% of the theoretical density. The bending strength of the shaped bodies according to the invention is ≧1100 MPa at room temperature and ≧850 MPa at 1000° C.

The shaped bodies according to the, invention correspond to the formula Si_{6-z}Al_{z}O_{z}N_{8-z}. The degree of substitution z is in this connection 0.20 to 0.60, preferably 0.22 to 0.54, in particularly 0.3 to 0.35.

In the preparation of the shaped bodies according to the invention the Al₂O₃ fraction in the amorphous phase drops by a factor of 0.2 to 0.7 during the sintering process compared to the initial composition of the sintering additives including the SiO₂ fraction of the Si₃N₄ raw material. This corresponds to a reduction of the Al₂O₃ fraction by around 30% to 80%.

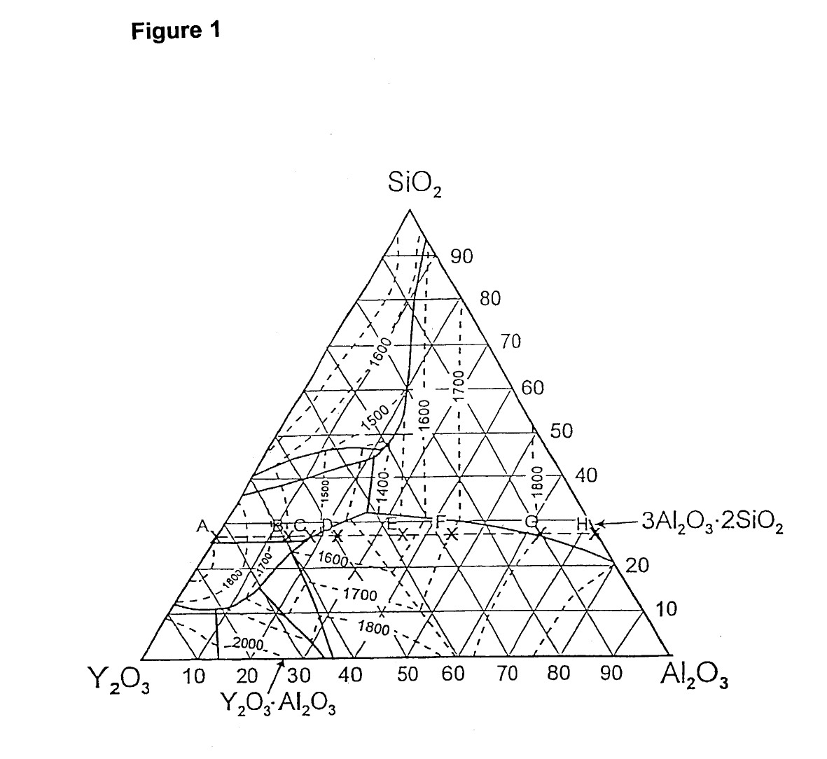

In order to produce the shaped bodies formulations were prepared obtaining up to 13 wt. % of sintering additives and the yttrium oxide and aluminium oxide fractions shown in Table 1 (referred to the total amount of additives including SiO₂) and a silicon nitride raw material, for example a silicon nitride raw material that was derived from the diimide process and that contained an initial oxygen content of 1.3%. The additive compositions of the ternary system SiO₂—Y₂O₃—Al₂O₃ illustrated in Table 1 and FIG. 1 were obtained with this initial oxygen content of the Si₃N₄ powder and its increase during the aqueous dispersion as well as the grinding in the agitator ball mill. The suspensions were plasticised and spray dried and then isostatically compressed at 2000 bar to form cylindrical shaped bodies. The pressed pieces were heated for 1 hour at 600° C. and were then sintered at temperatures of between 1800° C. and 1900° C., preferably at temperatures of between 1850° C. and 1875° C., in a gas-fired press sintering furnace with graphite heating elements at a maximum nitrogen pressure of 80 bar.

Test pieces of size 3×4×45 mm were produced from the gas pressure sintered materials by grinding, lapping and polishing, and were tested with regard to bending strength according to DIN 51110 by the 4-point bending test at room temperature and at 1000° C.

The thermal conductivity was measured on discs 12 mm in diameter and 1 mm thick by the xenon flash method.

The crystallite size distribution of plasma-etched round sections was determined by the automatic picture analysis of REM photographs. The microanalytical investigations of the glass phase and Si₃N₄ crystallites was performed with a scanning transmission electron microscope (STEM) in combination with energy-dispersive X-ray spectroscopy (EDX) and electron energy loss spectroscopy (EELS) of Ar⁺ ion-etched thin ground preparations.

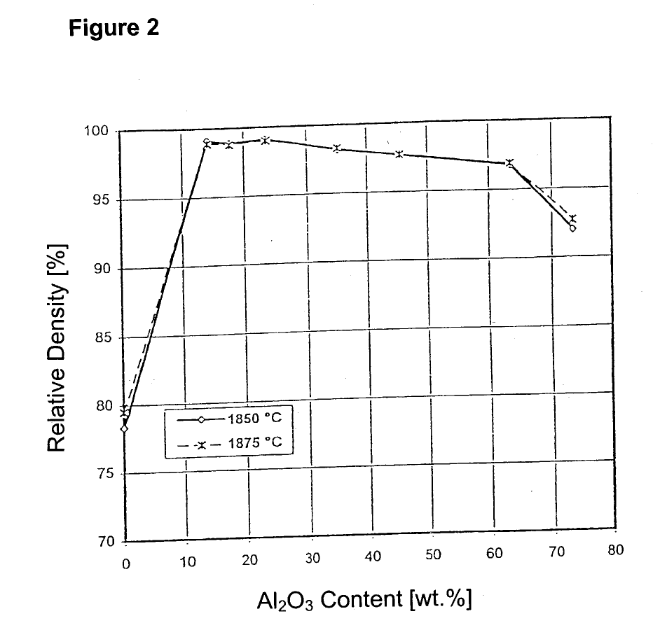

The sintering densities obtained under a nitrogen pressure of 80 bar at 1850° C. and 1875° C. are illustrated in FIG. 2 as a function of the Al₂O₃ content of the sintering additives, The correlation coefficient between the density and liquidus temperature of the sintering additives of the system SiO₂—Y₂O₃—Al₂O₃ is in this case 0.93 and confirms the influence of the temperature of the melt phase formation on the sintering compaction.

It has been found that sintering densities of greater than 97.5% of the theoretical density (TD), which are a prerequisite for high mechanical strengths, can be achieved in a relatively large range of the, Y/Al oxide ratios. These also constitute the main criterion for selecting materials.

Table 1 contains the mechanical strengths at room temperature and at a test temperature of 1000° C. achieved with different sintering temperatures, as well as measurement results of the thermal conductivity test (WLF) and of the linear thermal coefficient of expansion (WAK) in the range from 21° C. to 1000° C.

On account of the identical sintering conditions (temperature/pressure/time conditions) employed for all material compositions, it is not possible to obtain an optimum matching of these parameters to the compaction behaviour of the different materials. The mechanical properties at room temperature are accordingly also determined from the achieved sintering compaction as well as from the microstructure. By analogy with other series of experiments, it has been found that the pressed pieces of maximum density do not always exhibit the highest strengths. Pores having a diameter below the critical defect size that are homogeneously distributed in the structure may lead to the absorption of fracture energy and to crack branching.

Overall, despite widely varying material compositions, high mechanical strengths at room temperature have been able to be obtained, which can be increased still further by optimising the sintering parameters.

Suprisingly, the highest strengths at a test temperature of 1000° C. were achieved not with materials containing high Y₂O₃ fractions (samples A, B, C, D), but with materials having a Y₂O₃/Al₂O₃ a ratio of the order of magnitude of 0.6-1.1 (see Table 1).

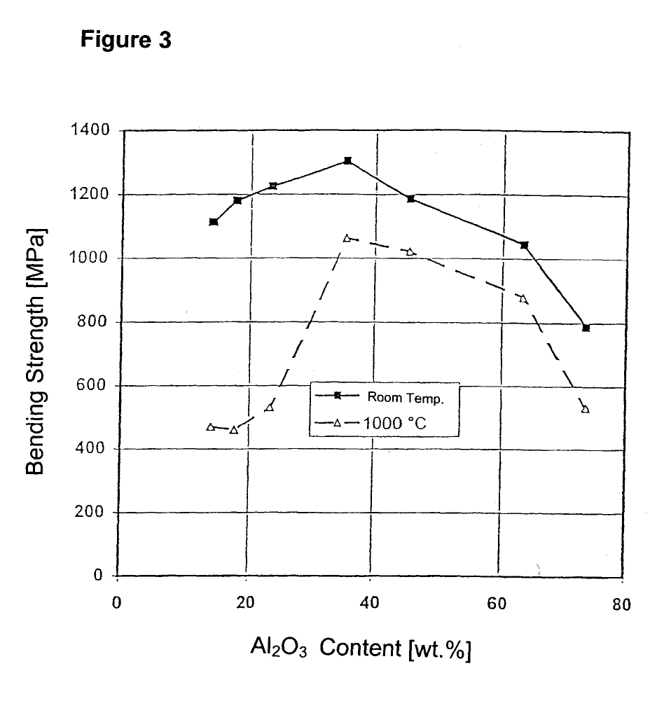

Bending strengths as a function of the Al₂O₃ fraction of is sintering additives (including SiO₂) that were sintered at a maximum temperature of 1875° C. are shown in FIG. 3. It can be seen from FIGS. 2 and 3 that with Al₂O₃ contents in the range of 15-35 wt. %, despite high sintering densities and high strengths at room temperature, markedly lower results were obtained in the strength test at 1000° C.

It is known that the amorphous phase in Si₃N₄ materials with sintering additives always surrounds the Si₃N₄ crystallites and, depending on the constituent amount, is also arranged in triple points and extended grain boundary regions. With the exception of sample H, which contained no Y₂O₃ additive, this was confirmed for the samples A to G. In sample H crystalline aluminium silicate phases were detected in some cases between the Si₃N₄ crystallites and in the triple points. In all other preparations no further crytalline phases are present &part from β-silicon nitride.

The size of the amorphous phase regions present in the triple points is of the order of magnitude of 200-1000 nm and is thus accessible to energy-dispersive X-ray spectroscopy.

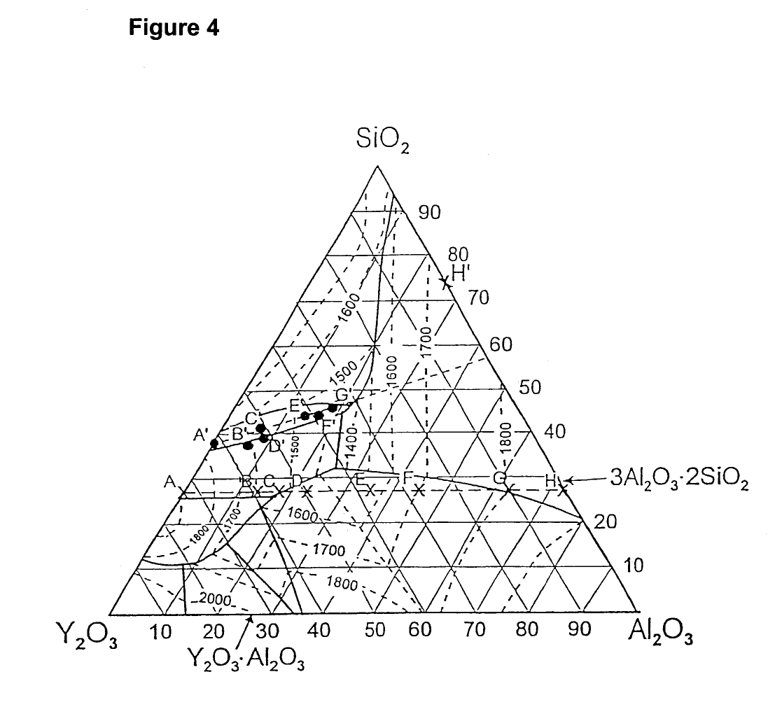

The elementaly analyses obtained by means of STEM/EDX of the grain boundary phases in the materials A-H are shown in Table 3. If the measured oxide mass proportions are plotted on the phase diagram SiO₂—Y₂O₃—Al₂O₃, then it is found that the amorphous phase has been enriched during the liquid phase sintering process with SiO₂ (including N) compared to the initial composition of the sintering additives (including SiO₂) (FIG. 4). In sample B with an Al₂O₃ content of 14%, an oxygen to nitrogen ratio of 6:1 in the amorphous phase was determined by means of EELS. In all yttrium oxide-containing and aluminium oxide-containing substances there was also a limited accumulation of Al₂O₃ due to the dissolution of Al³⁺ in the Si₃N₄ lattice. In this connection the vitreous phase compositions of the samples A-G are arranged on a line inclined at an angle of ca. 20° C. relative to the initial composition.

The crystalline silicate phase of sample H contains ca. 74 wt. % of SiO₂ and 26 wt. % of Al₂O₃, and at the sintering temperatures that are employed lies in the precipitation field of mullite. The Y-rich starting mixtures C and D yield amorphous phases whose position in the phase diagram (disregarding the influence of N) is displaced towards higher liquidus temperatures, which according to th existing stage of knowledge should have a positive influence on the high temperature strength (C′-ca. 1580° C.; D′-ca. 1575° C.) In the case of the initial concentration B the liquidus temperature remains virtually unchanged (FIG. 4).

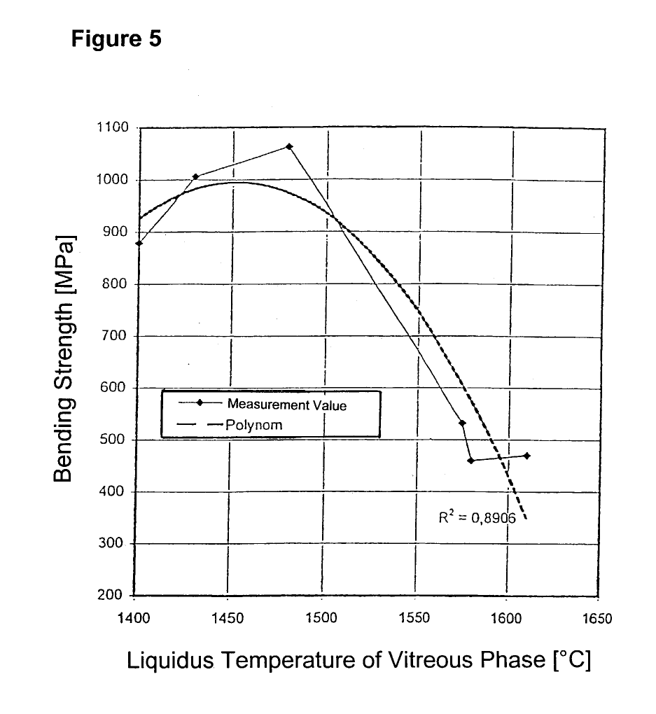

The samples B, F and G on the other hand lie at lower liquidus temperatures after the sintering: E′-ca. 1480° C.; F′-ca. 1430° C.; G′-ca. 1400° C. If the softening behaviour of the amorphous phase is significant for the short-term stress of the bending strength test at 1000° C. this would have a clearly negative effect on the measurement results. Table 1 and FIG. 5 illustrate however that this influence is surprisingly the opposite.

The STEM/EDX analysis of the Si₃N₄ crystallite shows that, with increasing initial Al₂O₃ content, higher Al fractions are dissolved in the Si₃N₄ (Table 2).

The ceramics produced according to the invention correspond to the general formula Si_{6-z}Al_{z}O_{z}N_{8-z}. The degrees of substitution of the ceramics according to the invention are in the range from z=0.22 (sample B) to 0.54 (sample H).

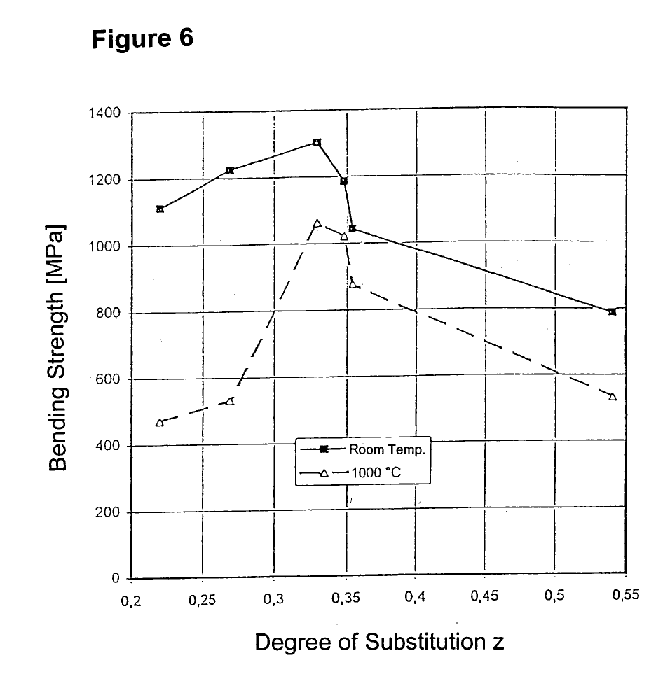

FIG. 6 illustrates the dependence of the mechanical strength on the degree of substitution. The highest strengths at room temperature and at 1000° C. may be obtained according to the invention if the degree of substitution z is in the range from 0.3 to 0.35.

The mechanical strength, in particular at elevated temperatures, is also influenced by thermal stresses that are produced by the differences in the coefficients of thermal expansion of silicon nitride and the amorphous grain boundary phase. According to measurement results obtained by Hyatt and Day (Journ. Amer. Ceram. Soc., 70 (1987) 10, C283-C287) the coefficient of expansion of yttrium-aluminium-silicate glasses with SiO₂ contents of 46% and 30% is affected only relatively slightly at changed Y₂O₃/Al₂O₃ ratios in the range from 1.5 to 3.1 and 1 to 2.75 (change in the coefficients of expansion of +0.8×10⁻⁶/K and +0.9×10⁻⁶/K respectively). Accordingly the influence of the possibly altered coefficients of expansion of the grain boundary phase in the materials described here is relatively slight.

It is known that the liquid phases formed in the Si₃N₄ and the sintering additive combinations Y₂O₃+MgO as well as Y₂O₃+Al₂O₃ may, despite the dissolution of nitrogen in the malt phase during the liquid phase sintering (4-8 atom %), be regarded to a first approximation as silicate glasses with SiO₂ and oxide additives (K. Oda and T. Yoshio; Journ. Cer. Soc. Jap. Int., 79 (1998) p. 1502), wherein the dissolution of nitrogen in glasses of the system SiO₃—Y₂O₃—Al₂O₃ raises their glass transition temperatures, hardness and fracture toughness and reduces the WAK (R. E. Loehman; Journ Amer. Cer. Soc., September-October 1979, 491-494). This influence should be substantially the same in the comparison samples and in the materials according to the invention. In the investigated concentration range of 30-45 wt. % of Y₂O₃, Oda and Yoshio (see above) found, with increasing yttrium content, higher densities, glass transition temperatures (870° C.-893° C.), higher hardness and falling fracture toughness of these glasses. Surprisingly however these results cannot be extrapolated to the ceramics according to the invention. With the liquidus temperatures of the sintering additives of the system SiO₂—Y₂O₃—Al₂O₃ the bending strength test results that are obtained at 1000° C. cannot be explained in this way.

The reasons for these surprising property changes can therefore only be attributed, apart from the different degree of substitution of the Si₃N₄crystallites, to the microstructure parameters. Accordingly microstructure investigations (crystallite size distribution, size and distribution of the amorphous grain boundary phase and fractography) were carried out on the ceramic produced according to the present invention.

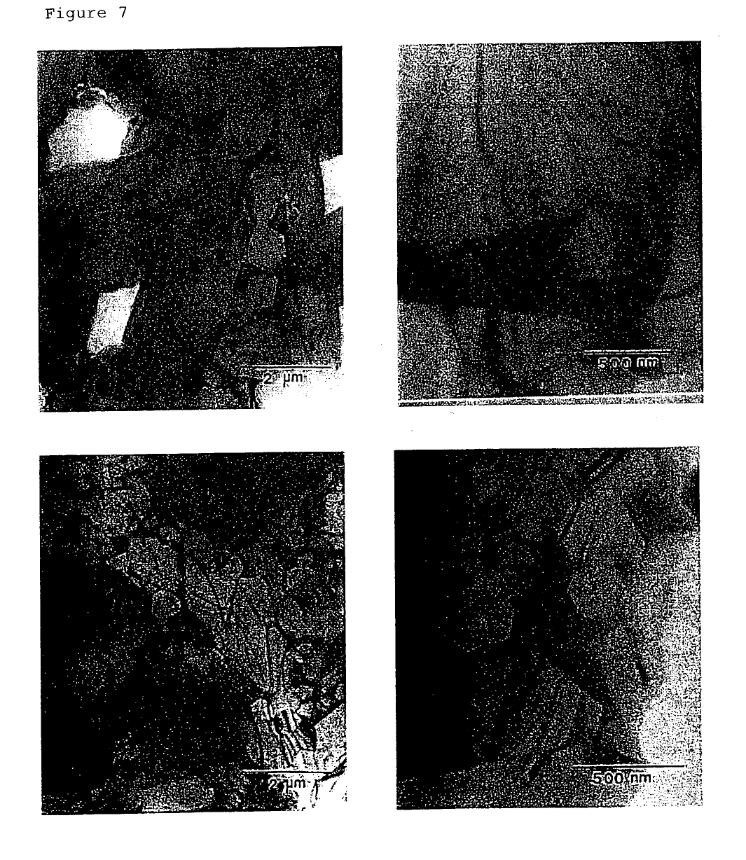

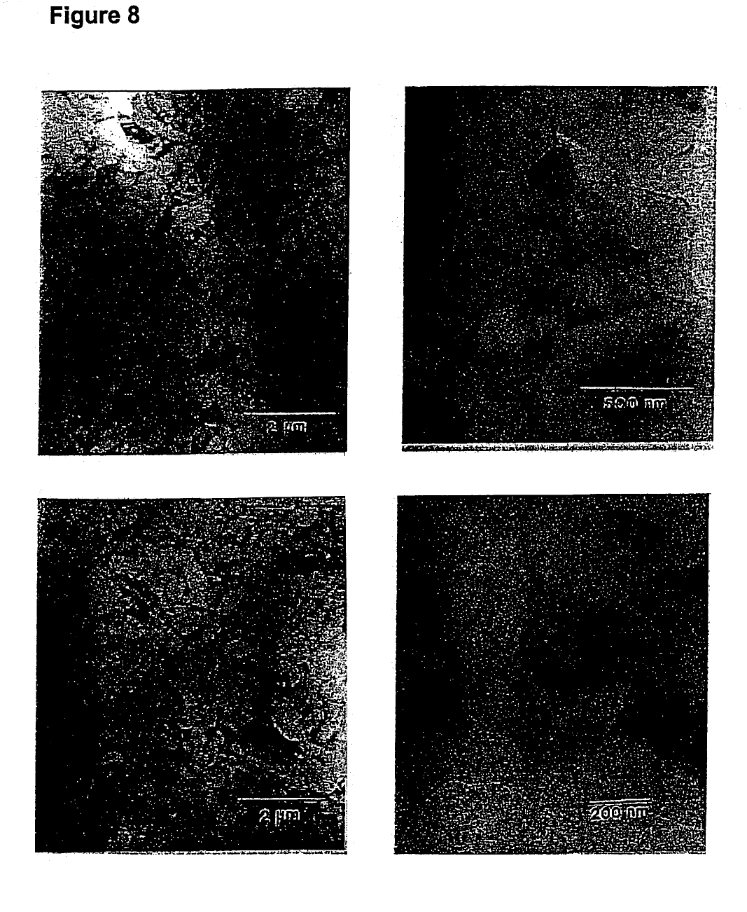

The structure images obtained by transmission electron microscopy at different magnifications (5000×, 10000×up to, in some cases, 9000×) in thin ground sections enable in particular the arrangement of the amorphous phase as well as the Si₃N₄ phase to be identified and analysed as described above. The visual evaluation of these images leads to the following assessment;

| Sample A | |
|---|---|
| (without Al₂O₃): | residual porosity with 1-2 μm size |
| | pores; vitreous phase regions ca. |
| | 500 nm wide and up to 1000 nm long; |
| | Si₃N₄ crystallites up to 2 μm wide |
| | and 8 μm long; many stress contours |
| | in the Si₂N₄; comparatively |
| | “coarsely crystalline” (FIG. 7) ; |
| Sample B | |
| (14% Al₂O₃): | vitreous phase regions max. ca. 400 |
| | nm wide and ca. 800 nm long; max. |
| | crystallite width 1.5-2 μm; many |
| | stress contours in the Si₃N₄; |
| | overall impression; less “coarsely |
| | crystalline” (FIG. 7) ; |
| Samples C and D: similar to B; | |
| Sample E | |
| (35% Al₂O₃): | vitreous phase regions max. ca. 200 |
| | nm large (finely divided); max. |
| | crystallite width 0.5-1 μm, max. |
| | grain length 2-3.5 μm; weakly |
| | pronounced stress contours; finely |
| | crystalline (FIG. 8) ; |
| Sample F | |
| (45% Al₂O₃): | vitreous phase regions max. ca. 150 |
| | nm wide and ca. 300 nm long; max. |
| | crystallite width 0.8-1.5 μm; |
| | individual crystallites with stress |
| | contours recognisable; finely |
| | crystalline; |
| Sample G | |
| (63% Al₂O₃): | vitreous phase regions max. ca. 200 |
| | nm large (finely divided) ; |
| | crystallite width 0.5-1 μm, max. |
| | grain length 4.5 μm; no stress |
| | contours or only slight stress |
| | contours recognisable (FIG. 8). |

It can be seen that the yttrium-rich samples, which also have a very low degree of substitution z, exhibit large-area amorphous regions and also relatively large Si₃N₄ crystallites, that are furthermore characterised by a plurality of stress contours, which are possible an indication of internal structural stresses that my exert an influence on the mechanical properties.

It is known that internal structural stresses are already produced by different positional orientations of adjacent crystallites during the cooling phase of polycrystalline materials that do not have a cubic lattice structure. Different coefficients of thermal expansion in different crystallographic directions and between different phases may reinforce this effect.

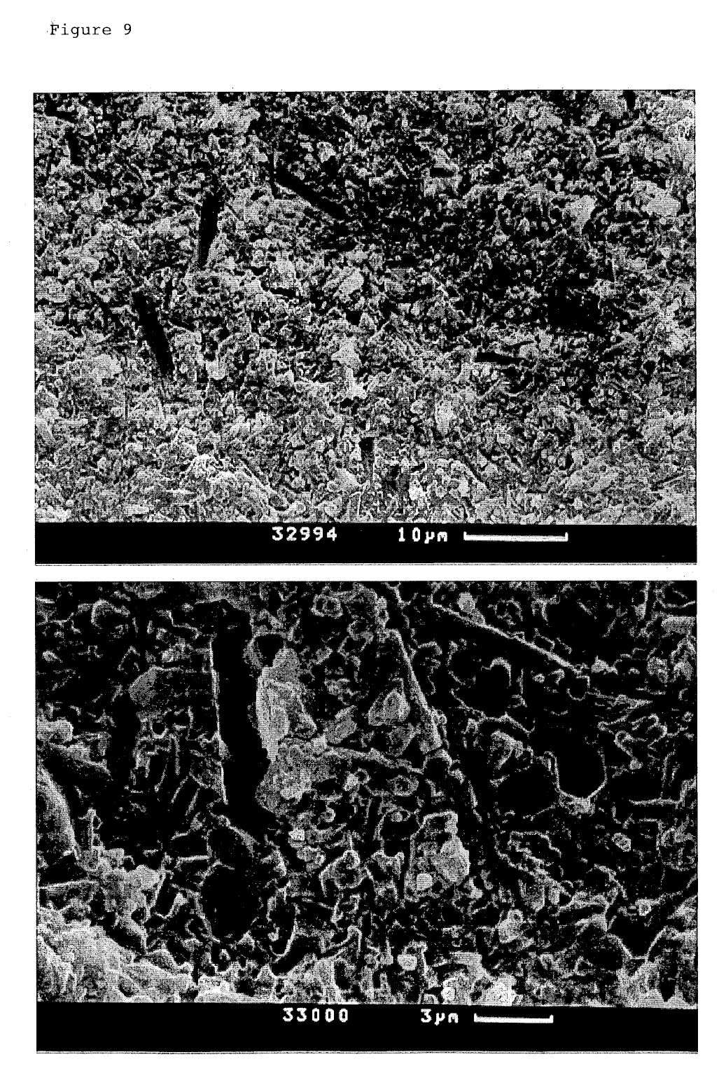

Fractographic investigations of the ceramics produced according to the invention characteristically reveal; especially in the case of samples with bending strengths less than 500 MPa (test temperature: 1000° C.), large acicular crystallites of ca. 8-10 μm grain length and 1.5-2.5 μm grain width at the fracture level in the vicinity of the fracture stress (FIG. 9). Higher magnification reveals debonding and pullout phenomena in larger crystallites both longitudinally as well as perpendicular to the image plane. The further away fracture defects are from the surface present in the mechanical test (tensile side) the greater the probability that the material will exhibit internal. tensile stresses. A crack can be recognised perpendicular to the longitudinal extension of the larger crystallite “withdrawn” during the fracture process in this partial section, the crack becoming more prominent as a result of secondary crack formation as well as thermal stresses (see arrow in FIG. 14). The ceramic material is in this case the material D (sintered at 1850° C.).

The main influencing factors that are responsible for the mechanical strength of the ceramics according to the invention in the temperature range up to 1000° C. are, suprisingly, microstructure parameters, namely the crystallite size, the different degree of substitution of the β′-sialons and/or their influence on the absolute values of the coefficients of thermal expansion and the differences in the coefficients of thermal expansion of the amorphous phase and Si₃N₄ crystallites, as well as in various crystallographic directions of the silicon nitride acicular crystallites.

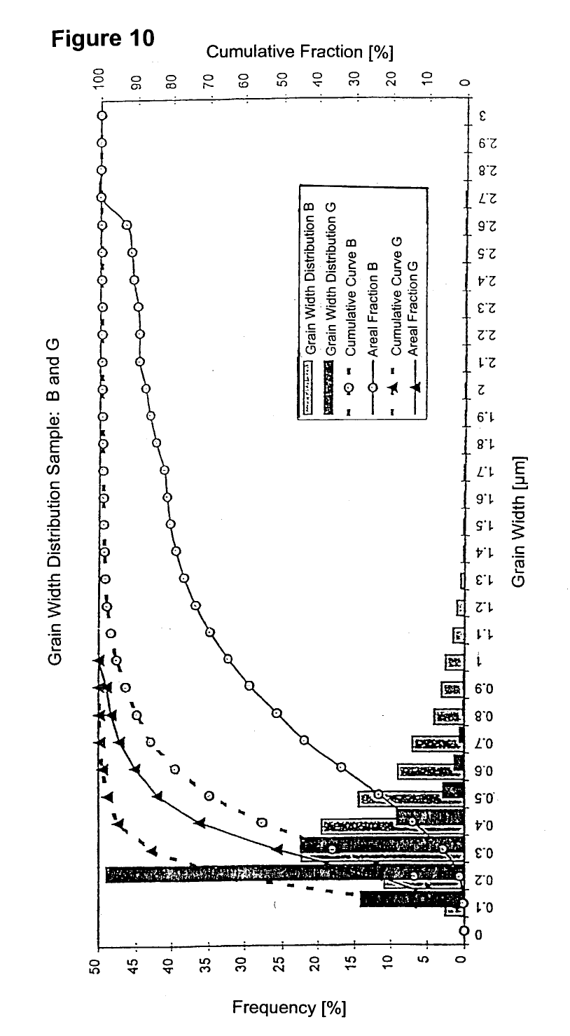

The results of the statistical microstructure investigations by means of automated image analysis of plasma-etched ground sections are illustrated in Table 4 and FIG. 10. The trend towards a more finely crystalline structure of Al₂O₃-rich samples already detected in STEM images is thereby confirmed. The differences in the mean grain width that have been determined from the cumulative frequency of the number of crystallites are relatively small in the samples B to E. The differences found in the analysis of the areal fractions of crystallites >8 μm gain length and >2 μm grain width, are more pronounced, and become significantly greater with increasing yttrium content and are no longer present in the finely crystalline sample G. These are the decisive influencing factors for the mechanical strengths.

The following conclusions ware found from the statistical microstructure analysis and the evaluation of the areal fractions of the larger crystallites:

The larger crystallites surprisingly have scarcely any effect on the strength at room temperature, but have a decisive effect on the bending strength at elevated temperatures The reason for the decrease in strength are the tensile stresses resulting from the differences in and the anisotropy of the linear coefficients of the thermal expansion of the lattice constituents of the silicon nitride ceramic. This effect is enhanced by the increase in the thermal expansion of crystallites with a smaller degree of substitution z of the yttrium-richer materials, as well as by their coarse-grain lattice structure.

The more coarsely crystalline materials save slightly higher fracture toughnesses (K_{1c} values: sample D: 8-9 MPa, m^{½}; sample E: ca. 7 MPa-m^{½}). The stresses produced when the temperature is raised and the crack propagation that occurs when the material strength is exceeded thus cannot be compensated.

The present invention has thus surprisingly demonstrated that, as a result of the increased Al₂O₃ content of the ceramics according to the invention, the bending strength is improved in a broader temperature range. With the increased Al₂O₃ content provided for according to the inventions, under appropriate sintering conditions the proportion of the Al³⁺ ions dissolved in the Si₃N₄ crystallites suprisingly increases in a disproportionate manner. The Al₂O₃ fraction in the glass phase is accordingly reduced compared to its initial content in he powder mixture. This result is all the more remarkable given that, according to the generally accepted ideas concerning Al₂O₃-rich sintering additives, it is not possible to produce silicon nitrides having high mechanical strength at elevated temperatures (see e.g. Hirosaki, N. et al. Journ. of Material Science 25 (1990) 1872-1876).

It was also found that by dissolving nitrogen in the glass phase, about ⅙ of the oxygen contained in the SiO₂ is replaced by nitrogen. To a first approximation these amorphous phases can furthermore be regarded as silicate glasses with SiO₃ and oxide additives (Oda and Yoshio (see above) and Braue, et al. J. Brit. Ceram. Soc. 37 (1986) 71-80). In this way the changes in the chemical composition starting from the initial mixture of the sintering additives and extending up to the amorphous phase formed from the melt phase during the cooling phase of the sintering process can also be illustrated in the phase diagram according to FIG. 4, as long as the N contents are roughly the same.

The substitution of Si^{½+} ions by Al³⁺ in the Si₃N₄ crystallites, which is also connected with the replacement of nitrogen ions by oxygen ions, is characterised by means of the degree of substitution z corresponding to the formula Si_{6-z}Al_{z}O_{z}N_{8-z}.

According to the prior art the melting point and the viscosity of the amorphous phase of the system Y₂O₃—Al₂O₃—SiO₂ contained in these materials should substantially determine the mechanical properties at elevated temperatures. It has surprisingly been found however that the ceramics according to the invention with a chemical composition of the amorphous phase whose liquidus temperature in the ternary system Y₂O₃—Al₂O₃—SiO₂ is at relatively low temperatures, nevertheless exhibit relatively high bending strengths at1000° C. (sea Table 1 and FIG. 1 of Appendix 1; comparison of the Materials E′,F′,G′ with B′,C′,D′).

This means that, surprisingly, the mechanical strength can be controlled and increased, especially at elevated temperatures, by adjusting the initial Al₂O₃ content and the degree of substitution z. Also, the strength at room temperature is thereby positively affected as long as 97.5% of the theoretically possible density is achieved by the dense sintering of the formed pieces, which can be effected by suitably matching the sintering temperature. This is not the case for the starting mixtures without Al₂O₃ (point A of the phase diagram in FIG. 1) and without Y₃O₃ (point H) on account of the insufficient liquid phase formation and the resultant relatively poor sintering density.

Also, the differences in the coefficients of expansion of the amorphous grain boundary phase and the Si₃N₄ crystallites may lead to thermal stresses during the heating up and cooling down of these materials that affect the mechanical strength. The change in the degree of substitution and thermal expansion of the matrix crystallites achieved according to the invention can, as a result of an improved matching of the coefficients of expansion to the lattice components, contribute to the increase in strength.

The fracture toughnesses (K_{1c} values) of the materials according to the invention are in the range from 7 to 8 MPa^{½} at room temperature and 5 to 7 MPa^{½} at 1000° C. These values constitute a further precondition for the long-term reliability of these materials under conditions of use, and are therefore ideally suited for application in plant and machinery construction, especially in engine construction.

The figures are as follows:

FIG. 1: ternary system Y₂O₃—Al₂O₃—SiO₃;

FIG. 2: sinter-dense gas pressure-sintered samples as a function of Al₂O₃ content;

FIG. 3: dependence of the mechanical strength on the Al₂O₃ content;

FIG. 4: ternary system Y₂O₃—Al₂O₃—SiO₂;

FIG. 5: correlation between liquidus temperature of the glass phase and high temperature bending strength (1000° C.);

FIG. 6: mechanical strength as a function of the degree of substitution (z);

FIG. 7: STEM images of the sample A (top) and B (bottom);

FIG. 8: STEM images of the sample E (top) a G (bottom);

FIG. 9: REM images of a fracture surface of sample D (test temperature 1000° C.);

FIG. 10: crystallite size distribution (grain width; sample B and G);

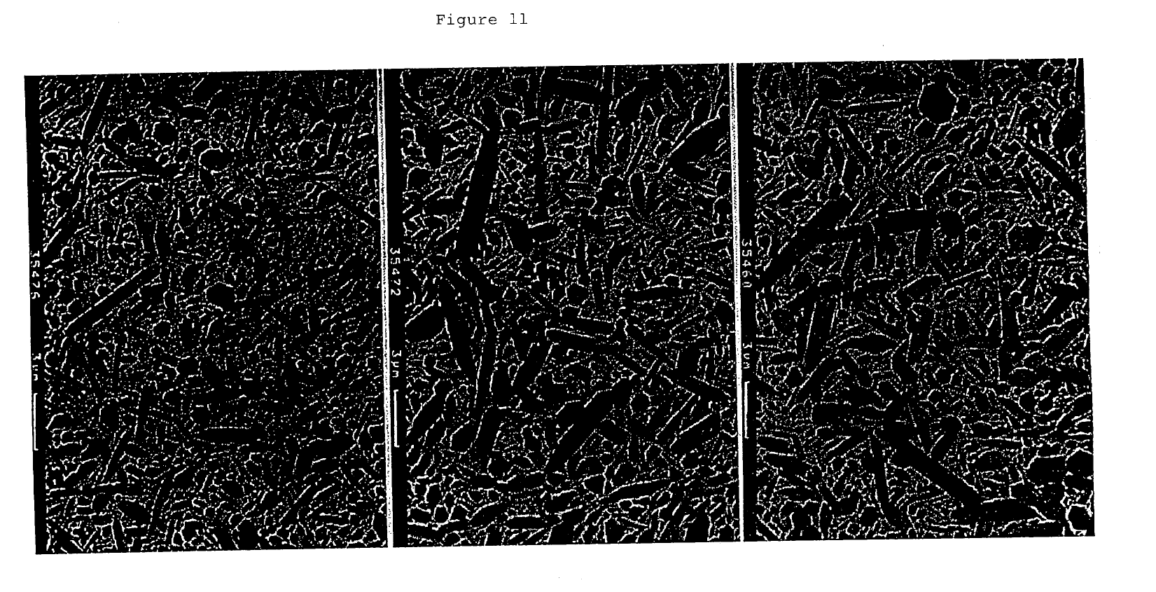

FIG. 11: microstructure of plasma-etched ground sections (REM; sample B (top) sample D (centre), sample G (bottom));

The following example are intended to illustrate the invention in more detail without however restricting the latter.

### EXAMPLE 1

### Comparison Example; Point C of FIG. 1

Mixtures of powders were prepared from 90 wt. % Si₃N₄ with an oxygen content of 1.3% and a specific surface of 12 m³/g as well as 2.5 wt. % Al₂O₃ and 7.5 wt. % Y₂O₃. This corresponds to a Y₂O₃/Al₂O₃ ratio of 3 (point C of FIG. 1). This mixture was mixed for three hours in aqueous suspension and ground in an agitator ball mill. After completion of the grinding 2 wt. % of a plasticising agent in the form of polyvinyl alcohol (Mowiol GE 04/86) and polyethylene glycol with a molecular weight of 400 in a ratio of 1:1 was mixed with the slurry and was dried in a spray drier with a double nozzle to a residual moisture content of 0.8% and then granulated.

The shaped bodies were then produced by means of isostatic compression at a pressure of 2000 bar. Sintering was carried out for 2 hours at a temperature of 1875° C. and a maximum nitrogen pressure of 80 bar. Bending test samples having the dimensions 3 mm×4 mm×45 m were produced from the shaped pieces by grinding, lapping and polishing. The 4-point bending strength was then tested according to DIN 51 110 at room temperature and at a temperature of 1000° C. The test results are summarised in Table 1.

### EXAMPLE 2

### Comparison Example; Point D of FIG. 1

The powder mixture consisted of 90 wt. % Si₃N₄, 3.3 wt. % Al₂O₃ and 6.7 wt. % Y₂O₃. This corresponds to a Y₂O₃/Al₂O₃ ratrio of ca. 2. All tke further process and test procedures corresponded to those of Example 1 (for test strength results, see Table 1).

### EXAMPLE 3

### According to the Invention; Point B of E of FIG. 1

The following powder mixture was prepared: 90 wt. % Si₃N₄, 5.0 wt. % Al₂O₃ and 5.0 wt. % Y₂O₃. This corresponds to a Y₂O₃/Al₂O₃ ratio of 1.0. All further process and test procedures corresponded to those of Example 1 (for test strength results, see Table 1).

### EXAMPLE 4

### According to the Invention; Point F of FIG. 1

The following powder mixture was prepared: 89.6 wt. % Si₃N₄, 6.25 wt. % Al₂O₃, 3.75 wt. % Y₂O₃ and 0.4 wt. % HfO₂. This corresponds to a Y₂O₃+HfO₂/Al₂O₃ ratio of 0.61. All further process and test procedures corresponded to those of Example 1 (for test strength results, see Table 1).

TABLE 1
Sintering Temperature (T_{Bl}) and Material
Properties

| | | | | | | | |
|---|---|---|---|---|---|---|---|
| B | 14.1 | 4.20 | 1850 | 99.1 | 1113 | 366 | 24.1 |
| | | | 1875 | 98.9 | 1112 | 470 | |
| D | 23.5 | 2.12 | 1850 | 99.1 | 1181 | 358 | 28.8 |
| | | | 1875 | 99 | 1225 | 532 | |
| F | 45.4 | 0.66 | 1850 | 97.7 | 1134 | 1022 | 16.5 |
| | | | 1875 | 97.7 | 1186 | 1006 | |
| H | 73.5 | 0 | 1850 | 92 | 723 | 470 | n.b. |
| | | Y₂O₃ | 1875 | 92.7 | 788 | 533 | |

* Bending strength at room temperature (mean value from 12 measurements)
** Bending strength at 1000° C. (mean value from 8 measurements)

TABLE 2
STEM Analysis of the Si₃N₄ Crystallites and Degree of
Substitution (z)

| | | | | |
|---|---|---|---|---|
| A | 0 | 100 | 0 | 0 |
| C | 4.6 | 95.4 | 0.048 | 0.276 |
| E | 5.4 | 94.6 | 0.057 | 0.330 |
| G | 5.92 | 94.08 | 0.063 | 0.354 |

TABLE 3
Chemical Analysis of the Grain Boundary Phase

| | | | | | |
|---|---|---|---|---|---|
| A | 52.88 | 0 | 46.52 | 0 | |
| C | 52.5 | 12.38 | 35.11 | 0.236 | 2.84 |
| E | 53.16 | 20.69 | 25.26 | 0.389 | 1.22 |
| G | 53.71 | 25.25 | 21.04 | 0.470 | 0.83 |
| A | 37.36 | 0 | 62.64 | 0 | |
| C | 40.35 | 8.07 | 51.58 | 0.200 | 6.39 |
| E | 43.82 | 14.47 | 41.72 | 0.330 | 2.88 |
| G | 46.31 | 18.47 | 35.22 | 0.399 | 1.91 |

* Crystalline phase

TABLE 4
Crystallite Sizes and Degree of Extension of the GPSN Samples

| | | | | |
|---|---|---|---|---|
| A | 0.60 | 7 | 8 | 30 |
| C | 0.35 | 4 | 6.5 | 4 |
| E | 0.25 | 3.4 | 7.5 | 3 |
| G | 0.19 | 2.5 | 7 | 0 |

* Crystallite < 2 μm long; ** Crystallite > 3 μm grain length; *** Crystallite > 2 μm wide and > 8 μm long

1. Shared body of sintered silicon nitride ceramic with high mechanical strength at room temperature and at elevated temperatures, characterised in that it corresponds to the formula Si_{6-z}Al_{z}O_{z}N_{8-z} wherein the degree of substitution z is 0.20 to 0.60, that it contains at least 87 wt. % of silicon nitride and up to 13 wt. % of an additive combination of Al₂O₃ and Y₂O₃ and the weight ratio of the additives Y₂O₃/Al₂O₃ is less than 1.1

2. Shaped body according to claim 1, characterised in that 1% to 20% of the Y₂O₃ fraction is replaced by another element of Group IVb of the periodic system or by an oxide thereof.

3. Shaped body according to claim 1 or 2, characterised in that it contains up to 1.0 wt. % HfO₂ and/or ZrO₂.

4. Shaped body according to one of claims 1 to 3, characterised in that the weight ratio of the additives Y₂O₃/Al₂O₃ is 0.2 to 1.09.

5. Shaped body according to of claims 1 to 4, characterised in that it has a density of >98% of the theoretical density.

6. Shaped body according to claims 1 to 5, characterised in that the bending strength of the shaped bodies according to the invention is ≧1100 MPa at room temperature and >850 MPa at 1000° C.

7. Shaped body according to one of claims 1 to 6, characterized in that the degree of substitution z is 0.22 to 0.54, preferably 0.3 to 0.35.

8. Shaped body according to one of claim 1 to 7, characterised in that the fracture toughness K_{1c} is >5.5 MPa·m^{½} at room temperature and >5 MPa·m^{½} at 1000° C.

9. Process for producing a shaped body according to one of claims 1 to 7, characterised in, that silicon nitride raw material having an initial oxygen content of 1.3% and up to 13 wt. % of an addative combination of Al₂O₃ and Y₂O₃ is mixed as sintering additive in a liquid dispersing agent, ground, plasticised and then spray dried, the resultant agglomerate is compressed into pressed pieces, and the pressed pieces are baked and then sintered at temperatures between 1600° C. and 1900° C. preferably at temperatures between 1850° C. and 1875° C.

10. Process according to claim 9, characterized in that 1% to 20% of the Y₂O₃ fraction is replaced by another element of Group IVb of the periodic. system or by an oxide thereof.

11. Process according to claim 9 or 10, characterised in that the mixture additionally contains up to 1.0 wt. % HfO₂ and/or ZrO₂.

12. Process according to one of claim 9 to 11, characterised in that the weight ratio of the additives Y₂O₃/A₂O₃ is 0.2 to 1.09.

13. Process according to one of claims 9 to 12, characterised in that the compression of the shaped pieces is carried out above 1500 bar and/or the sintering is carried out in a gas-fires press sintering furnace at a maximum nitrogen pressure of 80 bar.

14. Use of shaped bodies according to one of claims 1 to 8 in machine and plant construction as well as in combustion engine manufacture.
